(19) United States
(12) Patent Application Publication
(10) Pub. No.: US 2026/0225683 A1
(43) Pub. Date: Aug. 6, 2026

(54) MODIFIED FRAME REAR SUSPENSION BICYLCLE TO ENABLE ALTERNATIVE PIVOT POINT LOCATION IN ORDER TO PROVIDE ADDITIONAL ANTI-RISE VALUES

(71) Applicant: Priority Outdoor Products, LLC, New York, NY (US)

(72) Inventors: Fabien Gaston Lemasson, Lignieres-Orgeres (FR); Michael Schwartz, Douglaston, NY (US)

(21) Appl. No.: 19/045,948

(22) Filed: Feb. 5, 2025

(51) Int. Cl. B62K 25/28; B62K 3/02; B62M 9/121

(52) U.S. Cl. CPC B62K 25/28; B62K 3/02; B62M 9/121

(57) ABSTRACT

A rear suspension bicycle having a fixed rear suspension high pivot point located within an open area of a typical front triangle to provide unique anti-rise values not available when the rear suspension pivot point is located on a frame member of the front triangle. The front triangle may include one or more additional support members (e.g., frame member, tube, bracket) to provide mounting points for the fixed rear suspension high pivot point within the front triangle. The one or more additional support members may connect to at least some subset of a seat tube, a top tube, a down tube, a bottom bracket, and a head tube thereof. The one or more additional support members may replace one or more tubes of traditional front triangle. One or more tubes of the front triangle may be modified so as to extend within the open area of the typical front triangle.

### BACKGROUND

FIGS. 1A-B illustrate line diagrams of example chain driven rear suspension bicycles 100, 170. The bicycles 100, 170 include a frame made up of a front triangle 110 and a swingarm (rear triangle) 130. The front triangle 110 includes a seat tube 112, a top tube 114 and a down tube 116. The top tube 114 and the down tube 116 are connected to a head tube 118 that connects to handlebars (not illustrated) and a front fork 120 that is used to secure a front wheel (not illustrated) at a front wheel axle (axis) 122. The seat tube 112 and the down tube 116 are connected to each other via a bottom bracket shell (not separately illustrated, just shown as point of intersection between seat tube 112 and the down tube 116 for ease of illustration). The swingarm 130 may include a seatstay 132 and a chainstay 134, or a combined chain and seatstay 134 alone in case of a mono-arm swingarm. The seatstay 132 and the chainstay 134 meet to secure a rear wheel (not illustrated) at a rear wheel axle (axis) 136. For a mono-arm swingarm, simply the combined chain and seatstay 134 would secure the rear wheel.

The swingarm 130 may be connected to the front triangle 100 via a shock absorber or other linkages that are not illustrated for simplicity. The bicycle 100 also includes a rear suspension axis (main pivot point) where the swingarm 130 pivots with respect to the front triangle 110. The rear suspension axis may be a physical point or may be a floating or virtual pivot point (which may or may not coincide with a physical point on the bicycle frame). The floating or virtual pivot point for the rear suspension axis is found at an instant center that varies depending on the rear suspension design and kinematics. A floating pivot is not illustrated for ease of illustration and simplicity of explaining the basic components. A fixed-point rear suspension axis is physically located on the front triangle 110 (e.g., seat tube 112 or down tube 116). The bicycle 100 includes a rear suspension axis 140 located on the down tube 116 as illustrated in FIG. 1A. The bicycle 170 includes a rear suspension axis 180 located on the seat tube 112 as illustrated in FIG. 1B.

The bicycles 100, 170 also includes a drive train 150 for providing movement thereof. The drivetrain 150 consists of a drive chain (herein referred to as the “chain”) 152, a rear cassette 154 and a front chain ring 156. The rear cassette 154 is located on the rear wheel centered around the rear wheel axle 136. The rear cassette 154 includes a plurality of different sized cogs 158 (to achieve different gear ratios) for receiving and routing the chain 152. The front chain ring 156 is attached to a crank set (not illustrated) and rotates about a crank axis 160 on a bottom bracket (not illustrated). The crank axis 160 is simply shown as a point of intersection between seat tube 112 and the down tube 116 for ease of illustration. The chain 152 routes around the appropriate cog 158 of the rear cassette 154 and the front chainring 156. An upper portion of the chain 152U moves forward from the rear cassette 154 to the front chainring 156 and a lower portion of the chain 152L moves rearward from the front chainring 156 to the rear cassette 154. The bottom bracket enables the crank set and pedals (not illustrated) to be connected thereto. The crank set and pedals enable a user to pedal the bicycle 100 in order to engage the drive train 150 and move the bicycle 100. The pedaling causes the rotation of the front chain ring 156 which will in turn rotate the chain 152 and the appropriate cog 158 of the rear cassette 154 and the rotation of the cog 158 causes rotation of the rear wheel. If the bicycle 100 is an electric bicycle, it will include an electric motor (not illustrated) to provide, or assist with, the movement of the bicycle 100.

The amount of the chain 152 required to route around a larger cog 158 of the rear cassette 154 and the front chainring 156 is more than is required to route the chain 152 around a smaller cog 158. The extra chain 152 required is known as virtual chain growth. To account for the chain growth, a derailleur 162 is utilized to take up the slack therein based on the cog 158 that the chain 152 is routed around. The derailleur 162 is a rotating member 164 onto which two idler pulleys 166 are mounted. The derailleur 162 is secured to the swingarm 130 in close proximity to the rear cassette 154 and is spring loaded to rotate the rotating member 164 and the idler pulleys 166 based on the rear cog size 158. This allows for virtual chain growth that results from shifting the chain to different sized cogs 158 on the rear cassette 154.

In addition to the cog 158 utilized affecting chain growth, a vertical distance that the rear wheel axis 136 travels with respect to its resting position (known as vertical rear wheel travel) may result in chain growth. That is, as the rear wheel axis 136 moves upward along a path defined by the rear suspension axis 140, if the distance between the rear wheel axis 136 and the crank axis 160 increases, it will result in chain growth. As with most mechanical vehicle suspension systems, a bicycle 100 with rear suspension will be designed such that the swingarm 130, as it moves throughout its range of vertical rear wheel travel, will act upon a shock absorber resulting in a displacement of a spring.

FIG. 2 illustrates a line diagram of an example belt driven rear suspension bicycle 200. As the bicycle 200 has many of the same components as the bicycle 100, the same reference numbers are used to identify them and they are not described below to avoid redundancy. The bicycle 200 includes a drive train 250 that consists of a drive belt (herein referred to as the “belt”) 252, a rear sprocket 254 and a front sprocket 256. The sprockets 254, 256 simply route the belt 252 and do not provide different gear ratios (provides single external gear ratio). Accordingly, the bicycle 200 may provide a gear box (not illustrated) located at the intersection between seat tube 112 and the down tube 116 (e.g., the crank axis 160) or a geared hub (not illustrated) located at the rear wheel axle 136 to provide internal gear ratios. If used, the gear box is secured to the seat tube 112 and the down tube 116 via a gear box mounting bracket. The rear sprocket 254 is located on the rear wheel centered around the rear wheel axle 136. The front sprocket 256 is located on the gear box or the bottom bracket shell. The drive belt 252 routes around the rear sprocket 254 and the front sprocket 256 with the upper portion 252U moving forward from the rear sprocket 254 to the front sprocket 256 and a lower portion 252L moving rearward from the front sprocket 256 to the rear sprocket 254. If the gear box is used a crank set and pedals (not illustrated) are connected thereto to create the crank axis 160. If the geared hub is used the crank set and pedals are connected to the bottom bracket shell as discussed above with respect to FIG. 1. In either case, the crank axis 160 enables a user to pedal the bicycle 200. Pedaling causes the rotation of the front sprocket 256 which will in turn rotate the drive belt 252 which in turn will rotate the rear sprocket 254 and the rear wheel.

It should be noted that the bicycle 200 having only a single external gear ratio, is not limited to being a belt driven bicycle. Rather, the bicycle could be a chain driven bicycle and utilize a chain and front and rear chain rings instead of the drive belt 252, the front sprocket 256 and the rear sprocket 254. If the bicycle 200 is an electric bicycle, it will include an electric motor (not illustrated) to provide, or assist with, the movement of the bicycle 200.

As the bicycle 200 is a single external gear ratio there is no chain growth (typically called chain growth even when a drive belt 252 is utilized) to account for due to different sized cogs so there is no need for a derailleur to adjust the tension of the drive belt 252. However, as with the bicycle 100, vertical rear wheel travel may result in chain growth. Accordingly, the bicycle 200 includes a tensioner 262 to account for the chain growth resulting from vertical rear wheel travel. The tensioner 262 is a rotating member 264 onto which an idler pulley 266 is mounted. The tensioner 262 may be secured to the front triangle 110 and be located behind the front sprocket 256 (contacts the drive belt 252 behind the front sprocket 256). The tensioner 262 is spring loaded to rotate the rotating member 264 and the idler pulley 266 to adjust the path of the drive belt 252 based on the vertical rear wheel travel.

For the bicycle 200 illustrated, the rear suspension axis 140 is located on the down tube 116. A rear suspension axis could be located on the seat tube 112 in a similar manner to the rear suspension axis 180 that was illustrated in FIG. 1B.

The rear suspension of rear suspension bicycles (e.g., 100, 170, 200) tends to compress (squat) due to rearwards transfer of mass under acceleration (e.g., caused by pedaling) and extend (rise) due to forwards transfer of mass under deceleration (e.g., caused by front and/or rear wheel braking). It is desirable for the rear suspension bicycles to resist the compression (squatting) and extension (rising) of the rear suspension. Anti-squat is a built-in mechanical way to combat rear suspension compression (squatting) and anti-rise is a built-in mechanical way to combat rear suspension extension (rising).

FIG. 3 illustrates a graphic calculation of anti-rise and anti-squat values on an example bicycle (the bicycle is illustrated in similar fashion to the bicycle 100 but the calculations are not limited thereto). For a set suspension design, the anti-squat and anti-rise calculations depend on the position of the center of gravity 350 of the rider and bicycle at any given time, the front and rear suspension positions at any given time, the wheel size of the front and rear wheels 310, 345, and the drivetrain cog sizes 156, 158 in use for externally geared bicycles 100, 170 (or the sprocket sizes 254, 256 for internally geared bicycles 200 with a single external gear ratio). In calculating the anti-rise and anti-squat values, the following should be considered: (1) a line 300 between the rear suspension axis 140 and the rear wheel axis 136 (shown as dotted line which as illustrated overlaps the chainstay 134); (2) contact point 305 between the rear wheel 310 and ground 315; (3) a tangent point 320 between the drive line 152U and the front chainring 156; (4) a tangent point 325 between the drive line 152U and the appropriate cog 158 of the rear cassette 154; (5) line 330 between tangent points 320, 325 (shown as dotted line which as illustrated substantially overlaps the drive line 152U); (6) intersection 335 between lines 300, 330; (7) contact point 340 between the front wheel 345 and the ground 315; (8) line 355 extending upward from the contact point 340 and passing through the front wheel axis 222 (9) line 360 extending from the center of gravity 350 parallel to the ground 315, (10) anti-squat line 365 traversing the contact point 305 and the intersection 335; and (11) anti-rise line 370 traversing the contact point 305 and the suspension axis 140.

The anti-squat height 375 as measured from the ground 315 is the intersection of the anti-squat line 365 and the line 355. The anti-rise height 380 as measured from the ground 315 is the intersection of the anti-rise line 370 and the line 355. The center of gravity height 385 as measured from the ground 315 is the intersection of the line 360 and the line 355.

The graphical way of measuring the anti-squat takes into consideration the rear suspension instant center of rotation (the rear suspension axis 140 or 180) and the direction of the external force applied by the driveline to the rear suspension. The driveline force creates a torque that will usually serve to reduce the amount the rear suspension squats when pedaling. The anti-squat value can be in line with the driveline's member under tension and is based on the anti-squat height 375 compared to the center of gravity height 385 (375/385*100%).

As illustrated, the anti-squat height 375 is higher than the center of gravity height 385 so that the anti-squat value is greater than 100%. An anti-squat value greater than 100% results in the rear suspension extending (experiencing negative squat) under pedaling. This is a desirable trait of a suspension design since if the rearward transfer of mass from pedaling were to cause the shock absorber to compress, energy from pedaling would be expended for this (e.g., for purposes other than propelling the bike forward). In addition, the bicycle's frame pitch remains constant so the geometry of the bicycle remains static. An anti-squat value equal to 100% (anti-squat height 375 and the center of gravity height 385 are same) results in the rear suspension remaining stable (experiencing no squat) under pedaling. This is also a desirable result for the same aforementioned reasons.

An anti-squat value less than 100% (anti-squat height 375 less than the center of gravity height 385) results in the rear suspension compressing due to the rearward mass transfer from acceleration (experiencing squat) under pedaling. Depending on the degree to which this anti-squat value is less than 100%, this can be undesirable. An anti-squat value equal to 0% (anti-squat height 375 and the contact point 340 are same) results in the rear suspension compressing at the same rate as the rearward mass transfer from acceleration (no anti-squat properties) under pedaling. This is an undesirable result because it would result in a too great change in frame pitch angle consequently overloading the rear wheel and discharging the front wheel, affecting traction, and also putting the rider in an unstable position. This combined to the cyclic nature of the pedaling movement induces what is referred to as suspension bob, which is highly undesirable.

The graphical way of measuring the anti-rise only takes into consideration the rear suspension instant center of rotation (140 or 180). The rear wheel braking force at the ground contact patch creates a torque impulse that will usually serve to reduce the amount the rear suspension rises when braking. The anti-rise could be seen as a “frame pitch correcting factor” that is most useful when riding down steep slopes in order to reduce the risk of the rider going over the handlebars, as the torque impulse caused by braking forces serves to compress the suspension i.e. induce squat. The braking force to slow down the bicycle and rider is largely achieved through the front brake. The anti-rise value is based on the anti-rise height 380 compared to the center of gravity height 385 (380/385*100%).

As illustrated, the anti-rise height 380 is lower than the center of gravity height 385 so the anti-rise value is less than 100%. An anti-rise value less than 100% results in the rear suspension extending at a lesser rate (experiencing reduced rise). Depending on the degree to which this anti-rise value is less than 100%, this can be undesirable. An anti-rise value greater than 100% (anti-rise height 380 greater than the center of gravity height 385) results in the rear suspension compressing (negative rise) under rear wheel braking. This is a desirable trait of a suspension design since if the front suspension were to compress too greatly under deceleration, it could destabilize the rider. Counteracting the front suspension dive by a controlled amount of rear suspension compression allows a rider to more easily control the bicycle. An anti-rise value equal to 100% (anti-rise height 380 and the center of gravity height 385 are same) results in the rear suspension remaining stable (experiencing no rise) under rear wheel braking. This is also a desirable result for the same aforementioned reasons.

An anti-rise value equal to 0% (anti-rise height 380 and the contact point 340 are same) results in the rear suspension extending at the expected rate (no anti-rise properties) under rear wheel braking. This is an undesirable result because it would result in a too great change in frame pitch angle consequently overloading the front wheel and discharging the rear wheel, affecting traction, and also putting the rider in an unstable position, more prone to falling over the handlebars. An anti-rise value less than 0% (anti-rise height 380 below the contact point 340) results in the rear suspension extending more than the expected rate (experiencing an increased rise) under rear wheel braking. This is also an undesirable result for the reasons noted above.

The location of the rear suspension axis 140 or 180 impacts the anti-squat and anti-rise parameters that may be achieved. The placement of a fixed-point rear suspension axis 140 or 180 on the front triangle 110 (e.g., seat tube 112, down tube 116) limits the anti-rise parameters that may be obtained. What is needed is a bicycle that can provide additional anti-rise parameters.

### BRIEF DESCRIPTION OF DRAWINGS

The features and advantages of the various embodiments will become apparent from the following detailed description in which:

FIGS. 1A-B illustrate line diagrams of example chain driven rear suspension bicycles.

FIG. 2 illustrates a line diagram of an example belt driven rear suspension bicycle.

FIG. 3 illustrates a graphic calculation of anti-rise and anti-squat values on the example bicycle.

FIG. 4 illustrates a simple line diagram of an example high pivot rear suspension bicycle, according to one embodiment.

FIG. 5 illustrates a simple line diagram of an example internally geared high pivot point rear suspension bicycle, according to one embodiment.

FIG. 6 illustrates anti-rise values that would be obtained for different suspension pivot locations, according to one embodiment.

FIGS. 7-11 illustrate simple line diagrams of example high pivot rear suspension bicycles having additional support members to enable the fixed pivot point to be located within the typical void area between the seat tube and the down tube, according to various embodiments.

FIGS. 12-13 illustrate simple line diagrams of example high pivot rear suspension bicycles having modified frame members to enable the fixed pivot point to be located within the typical void area between the seat tube and the down tube, according to various embodiments.

FIGS. 14-15 illustrate simple line diagrams of example high pivot rear suspension bicycles having a top tube at least partially replaced by additional support members to enable the fixed pivot point to be located within the typical void area normally located between the seat tube and the down tube, according to various embodiments.

### DETAILED DESCRIPTION

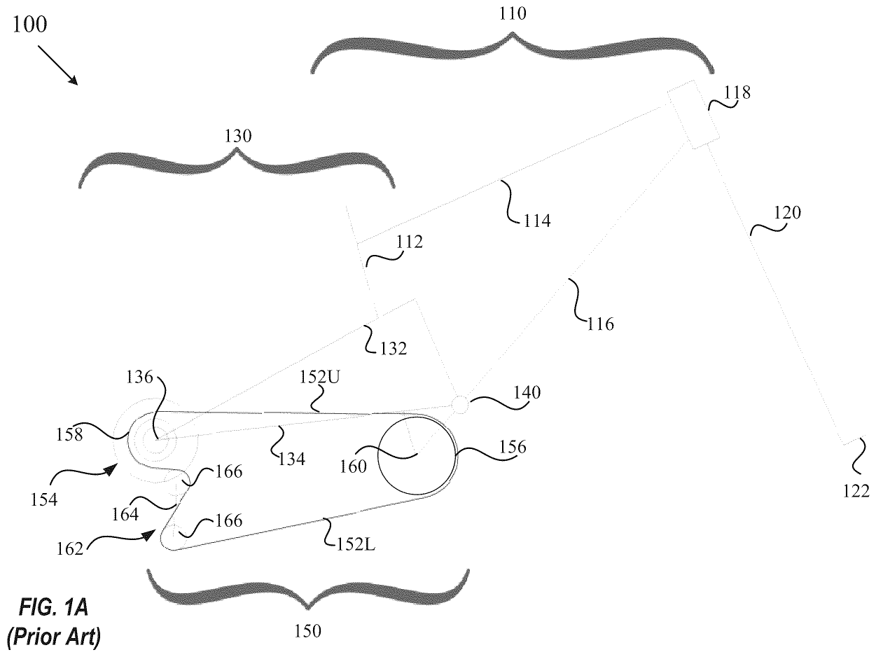

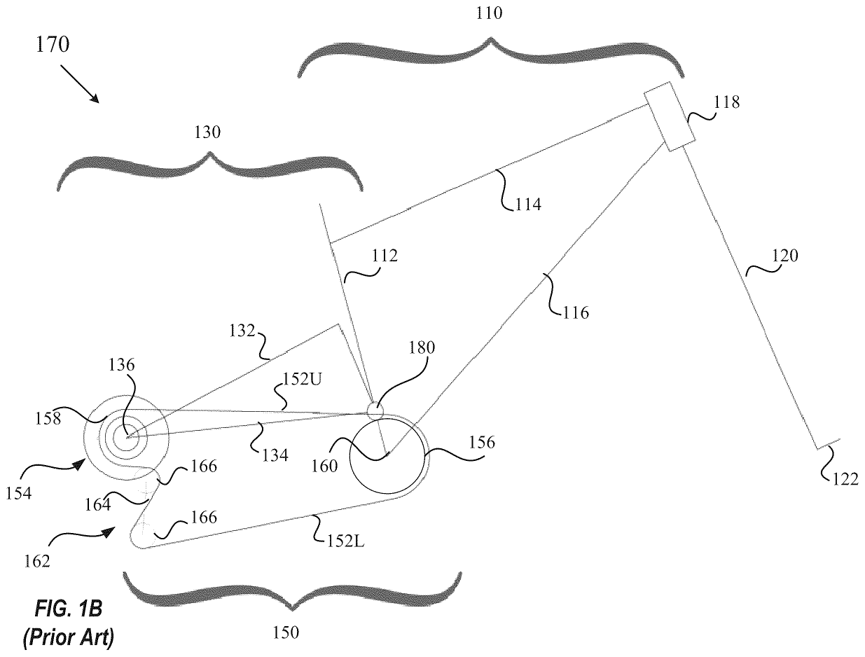

As illustrated in FIGS. 1A-B and 2, the most common rear suspension designs have a rear suspension axis (pivot point) 140, 180 near the crank axis 160 and the front chainring 156 or front sprocket 256. These rear suspension designs provide an axle path that rotates in a circular direction generally towards the front of the bicycle. This generally forward rotation is to the detriment of suspension performance, as the general force vector experienced by a rear wheel when it impacts a road obstacle is in a generally rearward direction. By moving the rear suspension pivot point higher (e.g., further above the crank axis 160 and the front chainring/sprocket 156, 256), the axle path of a bicycle becomes more rearward, better matching the direction of the force vector imparted by a rear wheel impact. A high rear suspension pivot point bicycle is one where the rear suspension pivot point is located high enough that an idler pulley is required to route the chain or drive belt 152, 252 coming from the rear cassette 154 or rear sprocket 254 to the front chainring/sprocket 156, 256. Bicycles having high rear suspension pivot points are becoming popular as they provide improved suspension control and a smoother ride in rough terrain.

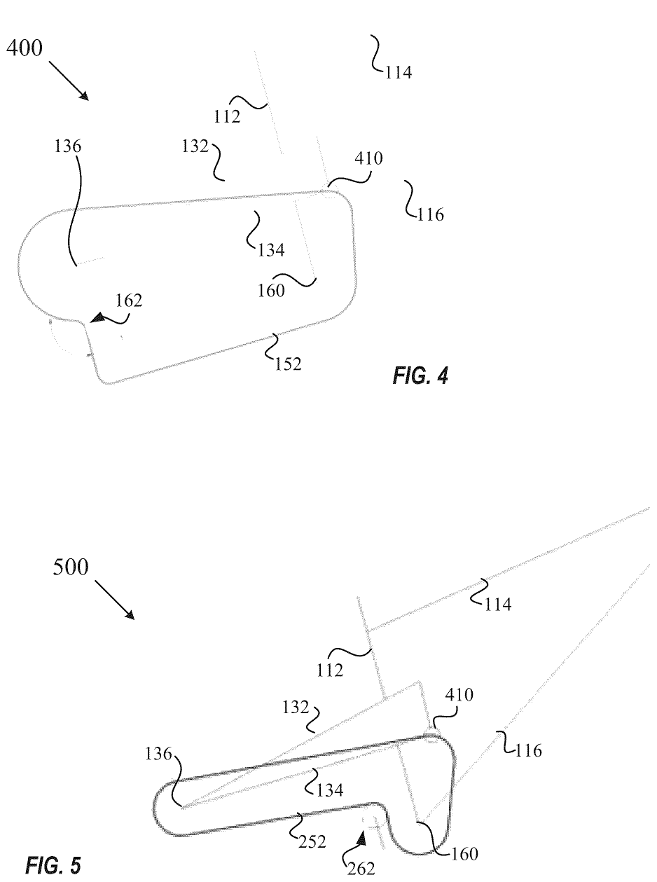

FIG. 4 illustrates a simple line diagram of an example multi-geared (chain driven) high pivot rear suspension bicycle 400 (similar to the bicycle 100). The bicycle 400 includes a rear suspension axis 410 (main pivot point) that is higher than the rear suspension axis 140, 180 of bicycle 100, 170 respectively. The axle path of the bicycle 300 is accordingly substantially rearward. An idler pulley (not illustrated) is located in close proximity to the high rear suspension axis 410. The chain 152 is routed around a certain cog of the rear cassette (not illustrated or identified in simplified drawing) centered around the rear wheel axle 136, the idler pulley located in close proximity to the high rear suspension axis 310, the front chainring (not illustrated) centered around the crank axis 160 and the derailleur 162. The actual components of the derailleur 162 are not illustrated for simplicity. Rather, they are simply illustrated as adjusting the path that the chain 152 travels.

FIG. 5 illustrates a simple line diagrams of an example internally geared (e.g., belt driven) high pivot point rear suspension bicycle 500 (similar to the bicycle 200). The bicycle 500 includes a rear suspension axis 410 (main pivot point) that is higher than the rear suspension axis 140 of bicycle 200 (or the rear suspension 180 that was not illustrated for the internally geared rear suspension bicycle). The axle path of the bicycle 500 is accordingly substantially rearward. An idler pulley (not illustrated) is located in close proximity to the high rear suspension axis 410. The drive belt 252 is routed around the rear sprocket (not illustrated) centered around the rear wheel axle 136, the idler pulley located in close proximity to the high rear suspension axis 410 and the front sprocket (not illustrated) centered around the crank axis 160.

The use of high pivot point suspension bicycles 400, 500 makes the anti-squat value easily controlled by size and position of the idler. The anti-rise value is generally more difficult to control due to its direct relation to the suspension pivot location 410 and its physical need to be attached to a frame member of the front triangle 110 (e.g., seat tube 112, down tube 116). It's also often looked over, as the focus is often more on the anti-squat characteristics of the suspension design. But the high anti-rise values and the consequential high level of squat under rear wheel braking (often referred to as “brake jack”) is a point that is recurrent in high pivot bicycle reviews.

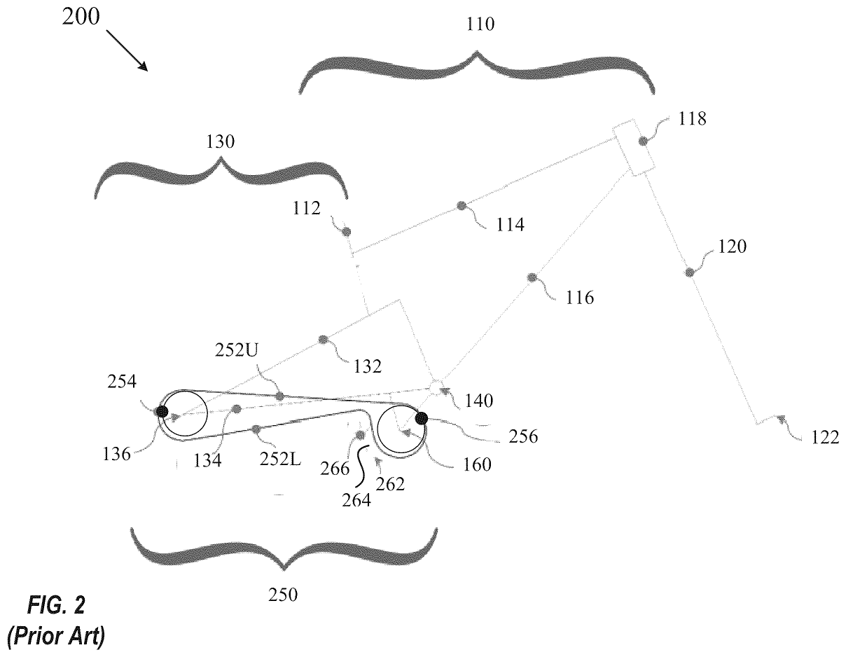

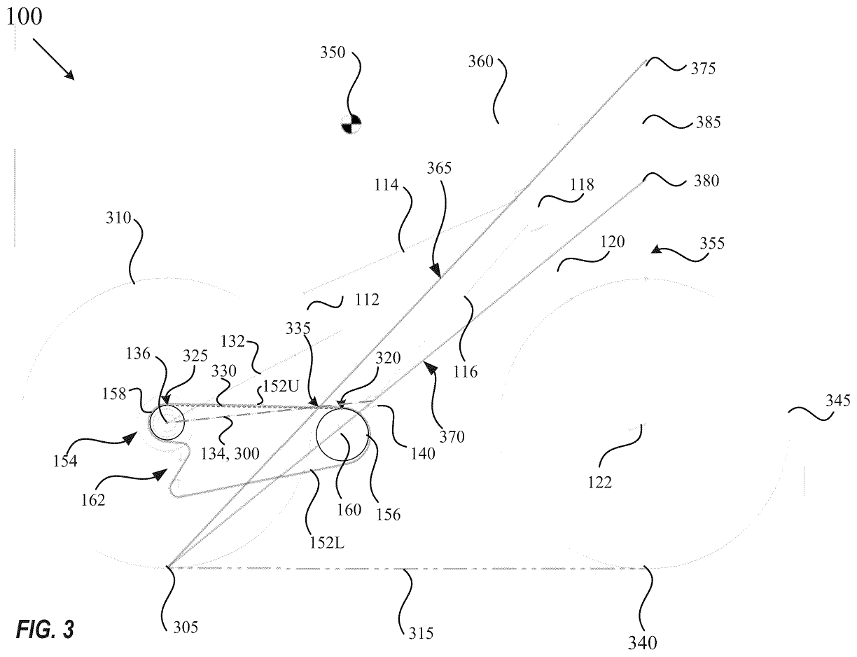

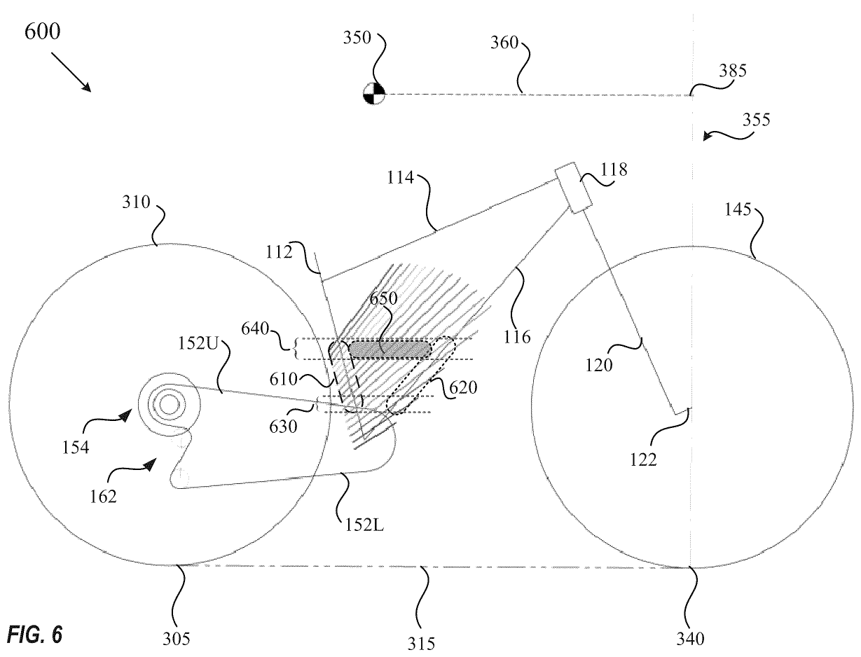

FIG. 6 illustrates anti-rise values that would be obtained for different suspension pivot locations. The anti-rise values are illustrated on an example geared bicycle 600 (similar to bicycles 100, 170 of FIGS. 1A-B or 400 of FIG. 4) having a rear cassette 154 and a derailleur 162. However, the anti-rise values that would be obtained for different suspension pivot locations is not limited to the geared bicycle 600. The anti-rise values could be obtained on an internally geared/belt-driven bicycle (similar to bicycle 200 of FIG. 2 or 500 of FIG. 5) without departing from the current scope. The rear suspension axis (pivot point) 140, 180, 410 is not illustrated. The chain 152 is illustrated as simply rotating around where the front chainring 156 (or front sprocket 256) would be located (not illustrated or labeled for ease) indicating that the bicycle 600 is a standard pivot rear suspension bicycle (similar to bicycles 100, 170 of FIGS. 1A-B or 200 of FIG. 2). However, the bicycle 600 is not limited thereto as it could be a high pivot rear suspension bicycle (similar to bicycle 400 of FIG. 4 or 500 of FIG. 5) without departing from the current scope.

A range of locations 610 on or near the seat tube 112 and a range of locations 620 on or near the down tube 116 where the rear suspension axis (pivot point) may be located are illustrated as dashed ovals surrounding the seat tube 112 and down tube 116 respectively. The approximate height ranges 630 where standard rear suspension pivot points (e.g., 140, 180) are typically located on the seat tube 112 or the down tube 116 is illustrated as being between the two red horizontal lines. The approximate height ranges 640 where high pivot rear suspension pivot points (e.g., 410) are typically located on the seat tube 112 or the down tube 116 is illustrated as being between the two blue horizontal lines.

The various colored lines extending upwards from the seat tube 112 to the down tube 116 are the anti-rise values associated with the bicycle 600. As illustrated, the anti-rise values start at 70% for the lowest line (dark blue) and the value increases 5% for each line thereabove and topping out at 150% for the highest line (dark red). As the anti-rise values extend upward at an angle, a rear suspension pivot point at a certain height on the seat tube 112 will provide a greater anti-rise value than a rear suspension pivot point at the same height on the down tube 116.

For example, the lower red line associated with standard rear suspension pivot points intersects with the seat tube 112 at the fifth (light blue) anti-rise line having a 90% value while it intersects the down tube 116 between the second and third anti-rise line so has an anti-rise value therebetween (approximately 77.5%). The upper red line intersects the seat tube 112 between the seventh and eight anti-rise line so has an anti-rise value therebetween (approximately 102.5%) while it intersects the down tube 116 at the third anti-rise line having an 80% value. The lower blue line associated with high pivot rear suspension pivot points intersects the seat tube 112 at the thirteenth anti-rise line (yellow) having a 130% value while it intersects the down tube 116 between the fourth and fifth anti-rise line so has an anti-rise value therebetween (approximately 87.5%). The upper blue line intersects the seat tube 112 at the seventeenth anti-rise line having a 150% value while it intersects the down tube 116 at the fifth anti-rise line having a 90% value.

As can be seen, the anti-rise values for standard pivot rear suspension bicycles are fairly close between the seat tube 112 and the down tube 116. However, the anti-rise values between the seat tube 112 and the down tube 116 are substantially different for the high pivot rear suspension bicycles.

Returning to the “brake jack” phenomenon, the only way to reduce it to more acceptable levels is to move the suspension pivot point forward (e.g., from seat tube 112 to down tube 116). For traditional suspension platforms, the suspension point cannot really be moved forward that much as the seat tube 112 and the down tube 116 are in close proximity to each other at that point. Such a movement would affect the anti-rise value but not to a great extent as discussed above. For high pivot suspension platforms, the suspension point can be moved forward a large amount. However, moving the high pivot point from the seat tube 112 to the down tube 116 will substantially reduce the anti-rise values as noted above. Keeping the suspension point on the seat tube 112 results in a common complaint that the rear suspension is compressing too much (is “packing up”) under braking, rendering the bike less maneuverable and reducing its ability to soak up bumps as a considerable amount of its suspension travel has already been used up.

For high pivot suspension platforms, an area 650 between the seat tube 112 and the down tube 116 at the approximate height ranges 640 could provide a further forward suspension point that would reduce the “brake jack” phenomenon as well as the “packing up” phenomenon and still provide a sufficient anti-rise value. A desirable anti-squat value is usually near or above 100% and probably should not surpass 120%. A desirable anti-rise value is usually near or above 100 and probably should not surpass 130%.

A bicycle that provides a manner to provide a fixed high pivot point rear suspension within the area 650 would enable the various desirable parameters to be obtained. What is needed is some type of support member (e.g., frame member, tube, bracket) within the void of the front triangle 110 to provide this fixed suspension point.

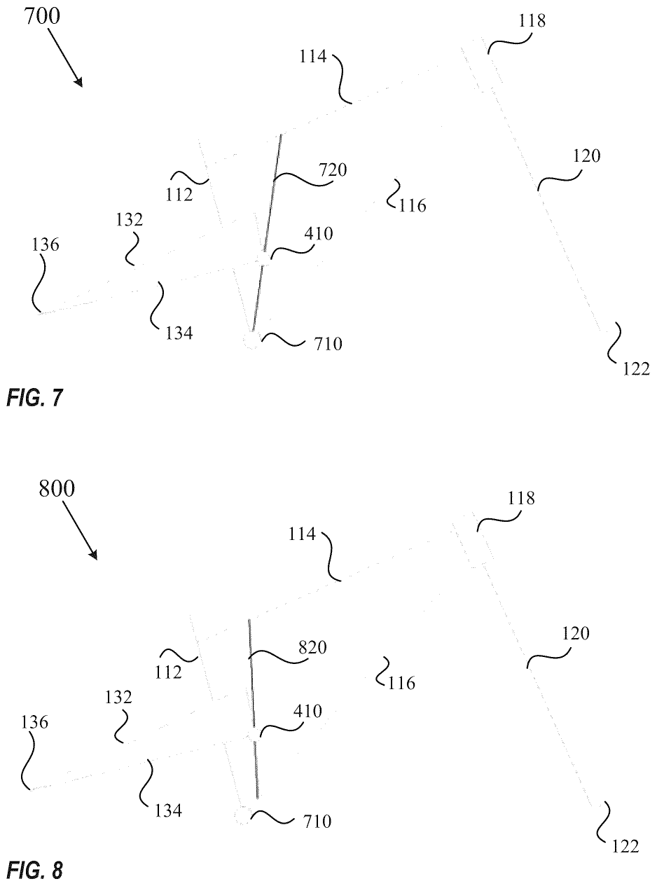

FIGS. 7-15 illustrate simple line diagrams of example high pivot rear suspension bicycles (similar to the bicycles 400, 500) having an additional support member (e.g., frame member, bracket, tube) added to the front triangle 110; an existing frame member (e.g., seat tube, down tube) of the front triangle 110 modified; and/or an existing frame member (e.g., down tube) of the front triangle 110 replaced by additional support members (e.g., frame member, bracket, tube) added to the front triangle 110 to enable the fixed pivot point 410 to be located within the area 650. Only the frame members of the bicycles are illustrated as the bicycles could be either multi-geared (chain driven) or internally geared (e.g., belt driven) such as those illustrated in FIG. 4 or 5. The same numbers will be used to identify the same parts and the parts previously discussed will not be discussed again. In previous figures, the crank axis 160 was illustrated as the intersection of the seat tube 112 and down tube 116 and the bottom bracket (for chain driven bicycles) or the gear box mounting bracket (for belt driven or internally geared bicycles) was not shown for ease of illustration. A mounting bracket 710 (bottom bracket or gear box bracket) is illustrated in these figures as it is utilized in some of the embodiments.

FIGS. 7-11 illustrate various embodiments of an additional support member being provided to the front triangle 110 to enable the fixed pivot point 410 to be located within the area 650.

FIG. 7 illustrates a bicycle 700 having an additional support (frame) member 720 added to the front triangle 110 that extends from the mounting bracket 710 to the top tube 114. The high pivot suspension point 410 is located on or near the support member 720.

FIG. 8 illustrates a bicycle 800 having an additional support (frame) member 820 extending from the down tube 116 to the top tube 114. The high pivot suspension point 410 is located on or near the support member 820.

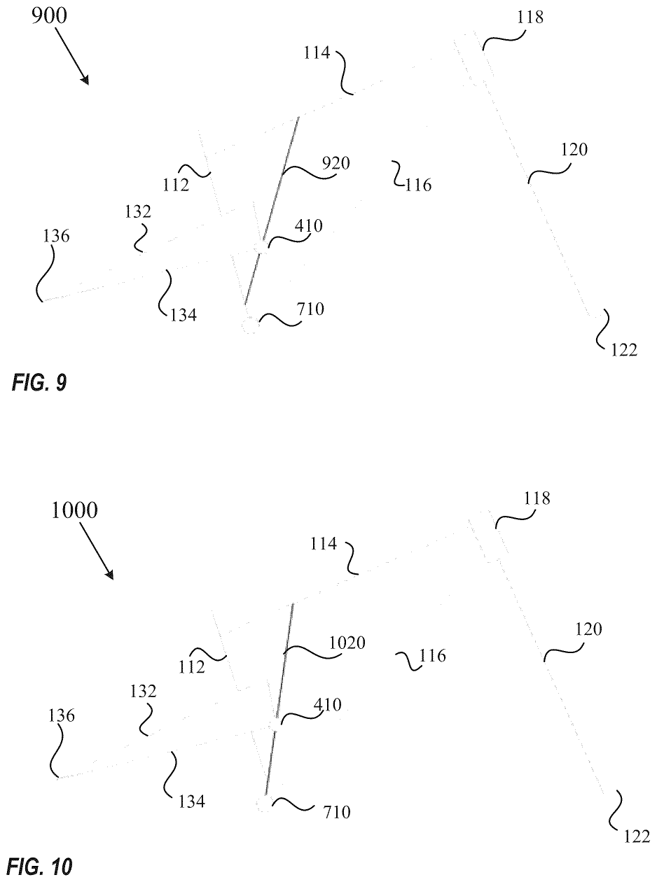

FIG. 9 illustrates a bicycle 900 having an additional support (frame) member 920 extending from the seat tube 112 to the top tube 114. The high pivot suspension point 410 is located on or near the support member 920.

FIG. 10 illustrates a bicycle 1000 having an additional support (frame) member 1020 extending from the mounting bracket 710 to the top tube 114 (like the bicycle 700 of FIG. 7). However, in this embodiment the seat tube 112 connects to the support member 1020 instead of the mounting bracket 710. The high pivot suspension point 410 is located on or near the support member 1020.

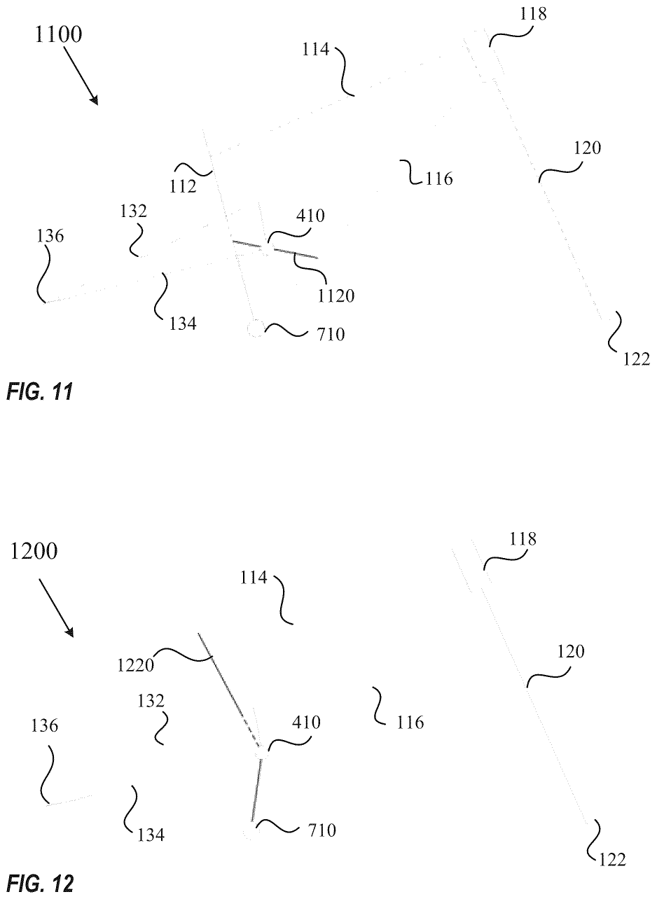

FIG. 11 illustrates a bicycle 1100 having an additional support (frame) member 1120 extending from the down tube 116 to the seat tube 112. The high pivot suspension point 410 is located on or near the support member 1120.

The additional support members of FIGS. 7-11 were illustrated as being frame members and/or tubes traversing between existing frame members (tubes) but are in no way intended to be limited thereto. Rather, the support members could be utilized in different configurations (e.g., number, location, orientation, shape, traversal path) without departing from the current scope. Furthermore, other typer of support members (e.g., brackets) that extend from a single frame member (e.g., seat tube, down tube) or between frame members could be utilized without departing from the current scope.

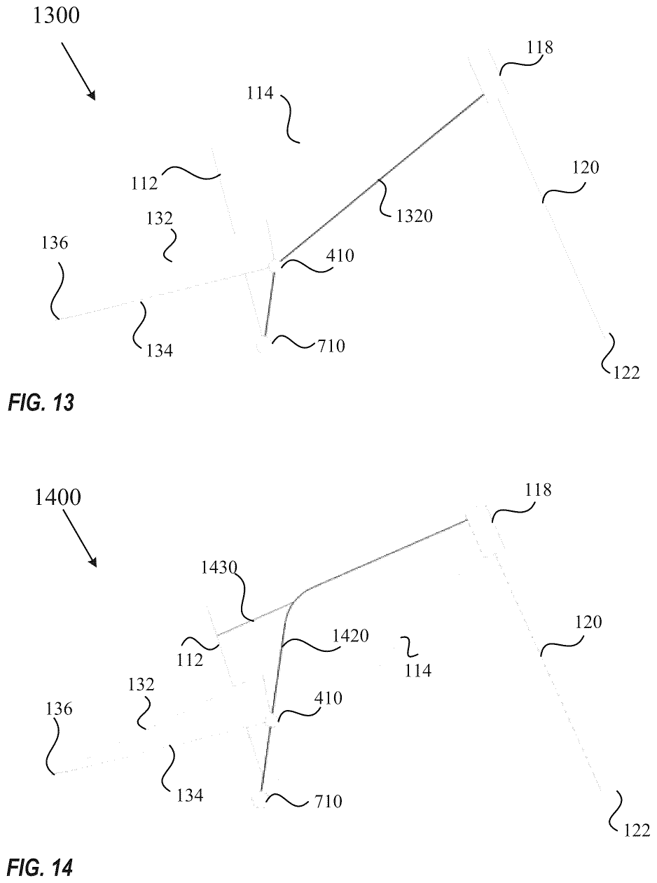

FIGS. 12-13 illustrate various embodiments of frame members (tubes) of the front triangle 110 being modified to enable the fixed pivot point 410 to be located within the area 650.

FIG. 12 illustrates a bicycle 1200 where a traditional seat tube 112 is replaced with a curved seat tube 1220. The seat tube 1220 extends downward from where a seat is typically located and then curves (or bends) backwards to the bottom bracket 710. The high pivot suspension point 410 is located on or near the curved seat tube 1220.

FIG. 13 illustrates a bicycle 1300 where a traditional down tube 116 is replaced with a curved down tube 1320. The down tube 1320 extends upward at a defined angle and then curves (or bends) forwards to the head tube 118. The initial angle of the down tube 1320 is steep enough that the down tube 1320 would only intersect with the head tube 118 at a height higher than a standard bicycle without the curve at a mid-point. The high pivot suspension point 410 is located on or near the curved down tube 1320.

The frame members modified are in no way intended to be limited to the embodiments illustrated in FIGS. 12-13. Rather, other frame members or combinations of frame members could be modified and the type of modifications may vary without departing from the current scope.

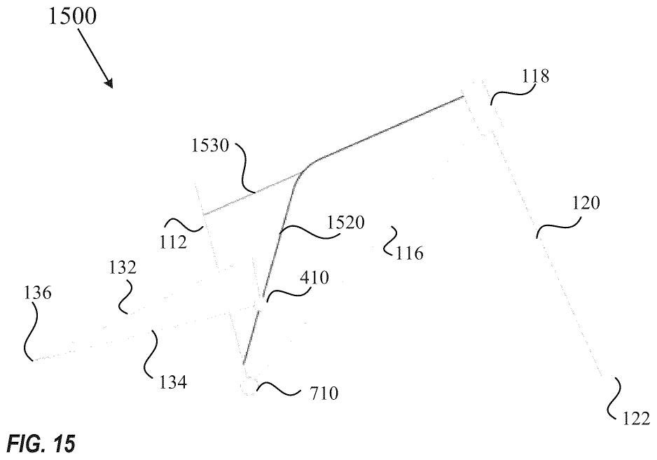

FIGS. 14-15 illustrate various embodiments of a frame member (e.g., top tube 114) of the front triangle 110 being replaced by additional support (frame) members to enable the fixed pivot point 410 to be located within the area 650.

FIG. 14 illustrates a bicycle 1400 where a traditional top tube 114 is replaced with a curved first support (frame) member 1420 and a second support (frame) member 1430. The curved first support member 1420 extends upwards from the mounting bracket 710 and then is curved at a mid-point towards the head tube 118 in similar fashion to the top tube 114. The second support member 1430 extends from the seat tube 112 to the curved mid-point of the first support member 1420 (is basically a shorter version of a top tube 114). As illustrated, the curved first support member 1420 extends upward from the mounting bracket 710 in similar fashion to the support member 1020 of FIG. 10 so the seat tube 112 connects to the support member 1420 instead of the mounting bracket 710. According to one embodiment, the first support member 1420 may extend from the mounting bracket 710 in similar fashion to the support member 720 of FIG. 7 where the seat tube 112 connects to the mounting bracket 710. The high pivot suspension point 410 is located on or near the curved first support member 1420.

FIG. 15 illustrates a bicycle 1500 where a traditional top tube 114 is replaced with a curved first support (frame) member 1520 and a second support (frame) member 1530. The curved first support member 1520 extends from a lower portion of the seat tube 112 (in similar fashion to the frame member 920 of FIG. 9) and then is curved at a mid-point towards the head tube 118 in similar fashion to the top tube 114. The second support member 1530 (e.g., modified top tube 114) extends from an upper portion of the seat tube 112 to the curved mid-point of the first support member 1520. As illustrated, the curved first support member 1520 extends upward from the seat tube 112 in similar fashion to the support member 920 of FIG. 9. The high pivot suspension point 410 is located on or near the curved first support member 1520.

FIGS. 14-15 illustrated the curved first support members 1420, 1520 extending from the mounting bracket 710 or the seat tube 112 but are not limited thereto. For example, a curved first support member may extend from the down tube 116 (in similar fashion to support member 820 of FIG. 8) and then curve at a mid-point towards the head tube 118 without departing from the current scope. The frame member replaced and the additional support members added are in no way intended to be limited to the embodiments illustrated in FIGS. 14-15. Rather, other frame members or combinations of frame members could be replaced, other additional support members or combinations of support members could be added, and/or frame members may be modified instead of being replaced without departing from the current scope.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

What is claimed is:

1. A rear suspension bicycle comprising
a frame including a front triangle and a swingarm;
a rear suspension pivot point between the front triangle and the swingarm, wherein the rear suspension pivot point is located within an interior of the front triangle, wherein the location of the rear suspension pivot point provides unique anti-rise values; and
a drive train providing movement from a crank axis where pedaling occurs to a rear wheel axis.

2. The rear suspension bicycle of claim 1, wherein the front triangle is formed by a seat tube, a top tube, and a down tube, wherein a mounting bracket is located where the seat tube and the down tube meet and a head tube is located where the top tube and the down tube meet, wherein an additional support member is located within the interior of the front triangle, and wherein the rear suspension pivot point is located on or near the additional support member.

3. The rear suspension bicycle of claim 2, wherein the additional support member is a bracket extending from at least a subset of the seat tube and the down tube.

4. The rear suspension bicycle of claim 2, wherein the additional support member is a frame member connected to at least some subset of the seat tube, the top tube, the down tube and the mounting bracket.

5. The rear suspension bicycle of claim 2, wherein the additional support member extends from the mounting bracket to the top tube.

6. The rear suspension bicycle of claim 2, wherein the additional support member extends from the seat tube to the top tube.

7. The rear suspension bicycle of claim 2, wherein the additional support member extends from the down tube to the top tube.

8. The rear suspension bicycle of claim 2, wherein the additional support member extends from the down tube to the seat tube.

9. The rear suspension bicycle of claim 1, wherein the front triangle includes a mounting bracket, a head tube, a seat tube, a down tube, a curved first support member extending upwards from a bottom of the bicycle and then curving at a mid-point toward the head tube, and a second support member extending from the seat tube to the mid-point of the curved first frame member, and wherein the rear suspension pivot point is located on or near the curved first support member.

10. The rear suspension bicycle of claim 9, wherein the curved first support member extends upwards from a portion of the seat tube in close proximity to the mounting bracket.

11. The rear suspension bicycle of claim 9, wherein the curved first support member extends upwards from the mounting bracket.

12. The rear suspension bicycle of claim 1, wherein the front triangle is formed by a seat tube, a top tube, a down tube, a mounting bracket located where the seat tube and the down tube meet, and a head tube located where the top tube and the down tube meet, wherein the seat tube extends downward and is then curved backwards toward the mounting bracket, wherein at least a portion of the curved seat tube is located within the interior of a typical front triangle, and wherein the rear suspension pivot point is located on or near the curved seat tube.

13. The rear suspension bicycle of claim 1, wherein the front triangle is formed by a seat tube, a top tube, a down tube, a mounting bracket located where the seat tube and the down tube meet, and a head tube located where the top tube and the down tube meet, wherein the down tube extends upward at an angle greater than required to intersect the head tube and is then curved forwards toward the head tube, wherein at least a portion of the curved down tube is located within the interior of a typical front triangle, and wherein the rear suspension pivot point is located on or near the curved down tube.

14. The rear suspension bicycle of claim 1, wherein the rear suspension pivot point is a fixed high pivot point.

15. A high pivot point rear suspension bicycle comprising
a frame including a front triangle and a swingarm, wherein the front triangle is formed between a seat, handlebars and a crank axis;
a rear suspension pivot point between the front triangle and the swingarm, wherein the rear suspension pivot point is located within the interior of the front triangle and provides unique anti-rise values and a predominantly rearward axle path; and
a drive train including a chain, a rear cassette having a plurality of cogs located at a rear wheel axis, an idler pulley located in close proximity to the rear suspension pivot point, a front chainring located at a crank axis, and a derailleur located in proximity to the rear cassette, wherein the chain traverses from the rear cassette to the idler pulley, from the idler pulley to the front chainring, from the front chainring to the derailleur, and from the derailleur back to the rear cassette, wherein the derailleur is to provide different driveline angles based on chain growth of the chain caused by the cog of the rear cassette selected and vertical rear wheel travel of the bicycle.

16. The high pivot point rear suspension bicycle of claim 15, wherein the front triangle is formed by a seat tube, a top tube, and a down tube, wherein a mounting bracket is located where the seat tube and the down tube meet and a head tube is located where the top tube and the down tube meet, wherein a support frame member is located within the interior of the front triangle, and wherein the rear suspension pivot point is located on or near the additional support member.

17. The high pivot point rear suspension bicycle of claim 16, wherein the additional support member is a frame member connected to at least some subset of the seat tube, the top tube, the down tube and the bottom bracket.

18. The high pivot point rear suspension bicycle of claim 16, wherein the additional support member is a bracket extending from at least a subset of the seat tube and the down tube.

19. The high pivot point rear suspension bicycle of claim 15, wherein the front triangle includes a bottom bracket, a head tube, a seat tube, a down tube, a curved first support member extending upwards from a bottom of the bicycle and then curving at a mid-point toward the head tube, and a second support member extending from the seat tube to the mid-point of the curved first support member, and wherein the rear suspension pivot point is located on or near the curved first support member.

20. The high pivot point rear suspension bicycle of claim 15, wherein the front triangle is formed by a seat tube, a top tube, a down tube, a bottom bracket located where the seat tube and the down tube meet, and a head tube located where the top tube and the down tube meet, wherein one of the seat tube and the down tube are curved so they extend from the bottom bracket into the interior of the front triangle before they are curved and extend upwards toward where a seat is to be located or forwards to the head tube respectively, and wherein the rear suspension pivot point is located on or near the curved seat tube or the curved down tube respectively.
